(19) United States
(12) Patent Application Publication
(10) Pub. No.: US 2016/0173628 A1
(43) Pub. Date: Jun. 16, 2016

(54) SYSTEM AND METHOD FOR SELECTIVE ADVERTISEMENT OF AVAILABILITY TO COMMUNICATE BASED ON LIGHT SOURCE AND ASSOCIATED LIGHTING PROPERTY

(71) Applicant: KONINKLIJKE PHILIPS N.V., Eindhoven (NL)

(72) Inventors: PHILIP STEVEN NEWTON, WAALRE (NL); RAMON ANTOINE WIRO CLOUT, EINDHOVEN (NL); BARTEL MARINUS VAN DE SLUIS, EINDHOVEN (NL); DZMITRY VIKTOROVICH ALIAKSEYEU, EINDHOVEN (NL); TATIANA ALEKSANDROVNA LASHINA, EINDHOVEN (NL)

(21) Appl. No.: 14/903,950

(22) PCT Filed: Jun. 30, 2014
(86) PCT No.: PCT/IB2014/062725

§ 371 Date: Jan. 8, 2016

Related U.S. Application Data
(60) Provisional application No. 61/843,965, filed on Jul. 9, 2013.

(51) Int. Cl. H04L 29/08; G08B 21/18

(52) U.S. Cl. CPC H04L 67/24; G08B 21/18

(57) ABSTRACT

Computer-readable media, methods and systems are provided herein for facilitating selective advertisement of a user's availability to communicate based on one or more lighting properties of one or more light sources (112-116, 742, 746). In various embodiments, an identifier and one or more lighting properties of a light source may be obtained by a computing device (100, 150, 700), directly (e.g., using an optical sensor) or through one or more computer networks (122). Based on this obtained data, the computing device may determine an activity of the user, and based on the determined activity, may facilitate selective advertisement of the user's availability to communicate over one or more social networks.

### TECHNICAL FIELD

The present invention is directed generally to automatic user status update and selective advertisement of a user's availability to communicate. More particularly, various inventive methods, computer-readable media, systems and apparatus disclosed herein relate to facilitation of selective advertisement of a user's availability to communicate, based on a light source and one or more lighting properties of the light source.

### BACKGROUND

As mobile computing devices such as smart phones and computing tablets become more ubiquitous, it is possible to communicate with people at nearly all times. This increased reachability has the negative side effect of increasing stress, as a person may be interrupted at any time. Technology exists to infer a user's availability to communicate based on various contextual sensors, such as the user's calendar, computer use, GPS location, etc. However, some of these context sensors, such as a user's calendar, require manual maintenance/updating by a user. If the user is not vigilant in this maintenance/updating, the context sensor may not be helpful in inferring the user's availability to communicate.

Social networks are increasingly being used for communication as well. Many of these social networks may include functionality that enables a social network user to advertise and/or update her “status.” In some cases, the user's status may be used by others to infer her availability to communicate. For example, if a user updates her social network status to “taking exam,” then other users of the social network may infer that the user would not wish to be disturbed except for extreme emergencies. However, this still may require the user to manually update her status, or to have her status updated based on contextual sensors that require manual user maintenance.

Thus, there is a need in the art to provide methods, systems, computer-readable media and apparatus that make it easier and/or more convenient to notify others of a user's availability to communicate, without relying on data from contextual sensors that require manual maintenance by the user.

### SUMMARY

The present disclosure is directed to facilitating selective advertisement of a user's availability to communicate. More particularly, various inventive computer-readable media (transitory and non-transitory), methods, systems and apparatus for facilitating selective advertisement of a user's availability to communicate based on one or more lighting properties of one or more light sources. For example, in some embodiments, one or more lighting properties of a particular light source may be determined and used to determine a user's current activity. Based on the determined user activity, the user's availability to communicate with others may be selectively advertised on one or more social networks.

Generally, in one aspect, a computing device such as a smart phone may be configured to obtain an identifier associated with a light source, determine one or more lighting properties of the light source, and facilitate selective advertisement of a first user's availability to communicate with a second user based on obtained identifier and the determined one or more lighting properties.

In various embodiments, the selective advertisement of the first user's availability to communicate may be further based on a relationship between the first user and the second user. In various versions, the relationship may be obtained from a social network to which the first and second users belong. In various versions, the selective advertisement may further include selection, for provision to the second user, of an availability status from a plurality of potential availability statuses based on the relationship between the first and second users.

In various versions, the plurality of potential availability statuses may be obtained from a social network to which the first and second users belong. In various versions, the computing device may be further configured to select an activity of the first user from a plurality of potential activities of the first user based on the determined one or more lighting properties of the light source and the obtained identifier. In various versions, the availability status may be selected from the plurality of potential availability statuses based on the selected activity. In various versions, the computing device may be further configured to receive, from the first user, one or more associations between the plurality of potential activities of the first user and the plurality of potential availability statuses. In various versions, the first user's availability to communicate may be selectively advertised on a social network to which the first and second users belong.

In various embodiments, the computing device may include a mobile computing device equipped with an optical sensor, and the determination of the one or more lighting properties may include detection of the one or more lighting properties using the optical sensor.

In various embodiments, the identifier associated with the light source may be obtained from a coded light signal received by the computing device from the light source. In various embodiments, the determination of the one or more lighting properties may include receiving, from the light source over one or more computer networks, an indication of the one or more lighting properties.

In various embodiments, the computing device may be further configured to receive, from the first user, an association between the identifier of the light source, one or more potential lighting properties of the light source, and one or more potential availability statuses of the first user. In various versions, the computing device may be further configured to provide a user interface configured to enable the first user to tag the light source within a rendered digital image of the light source and its surroundings.

In various embodiments, the computing device may be further configured to automatically generate, based on a characteristic of the light source, an association between the identifier of the light source, one or more potential lighting properties of the light source, and one or more potential availability statuses of the first user.

In various embodiments, the computing device may be further configured to receive, from the first user, an association between the identifier of the light source, one or more potential lighting properties of the light source, a potential availability status of the first user, and the second user.

In various embodiments, the computing device may be a wearable computing device. The facilitation may include provision of an instruction by the wearable computing device to a mobile computing device. The instruction may be configured to cause the mobile computing device to implement the selective advertisement.

In various embodiments, the computing device may be further configured to monitor lighting properties of the light source, and to selectively raise an alarm to one or more other users in response to an observed deviation from an established routine of lighting properties of the light source over time.

In various embodiments, the computing device may be a smart phone configured to alter an incoming message notification setting of the smart phone based on the determined one or more lighting properties and the obtained identifier.

In another aspect, a computer-implemented method may include obtaining, e.g., by a computing device, an identifier associated with a light source, determining, e.g., by the computing device, one or more lighting properties of the light source, and facilitating, e.g., by the computing device, selective advertisement of a first user's availability to communicate with a second user based on the obtained identifier and the determined one or more lighting properties.

In various embodiments, the selective advertisement of the first user's availability to communicate may be further based on a relationship between the first user and the second user. In various versions, the method may further include obtaining the relationship from a social network to which the first and second users belong. In various versions, the selective advertisement may include selection, for provision to the second user, of an availability status from a plurality of potential availability statuses based on the relationship between the first and second users.

In various versions, the method may further include obtaining, e.g., by the computing device, the plurality of potential availability statuses from a social network to which the first and second users belong. In various versions, the method may include selecting, e.g., by the computing device, an activity of the first user from a plurality of potential activities of the first user based on the determined one or more lighting properties of the light source and the obtained identifier. In various versions, the availability status may be selected from the plurality of potential availability statuses based on the selected activity. In various versions, the method may further include receiving, e.g., by the computing device from the first user, one or more associations between the plurality of potential activities of the first user and the plurality of potential availability statuses.

In various embodiments, the user's availability to communicate may be selectively advertised on a social network to which the first and second users belong. In various embodiments, the computing device may include a mobile computing device equipped with an optical sensor, and determining the one or more lighting properties may include detecting the one or more lighting properties using the optical sensor.

In various embodiments, obtaining the identifier associated with the light source may include obtaining the identifier from a coded light signal received by the computing device from the light source.

In another aspect, a computing system may include an optical sensor and a controller operably coupled with the optical sensor. In various embodiments, the controller may be configured to obtain, via the optical sensor, a lighting context comprising at least one identifier associated with a light source and one or more lighting properties of the at least one light source, and to facilitate selective advertisement of a first user's availability to communicate with a second user based on the obtained lighting context and a social networking relationship between the first user and the second user. In various embodiments, the controller may be configured to receive, from the first user, an association between the lighting context, a potential availability status of the first user, and the second user.

The term “light source” should be understood to refer to any one or more of a variety of radiation sources, including, but not limited to, LED-based sources, including one or more LEDs

The term “controller” is used herein generally to describe various apparatus relating to the operation of one or more light sources. A controller can be implemented in numerous ways (e.g., such as with dedicated hardware) to perform various functions discussed herein. A “processor” is one example of a controller which employs one or more microprocessors that may be programmed using software (e.g., microcode) to perform various functions discussed herein. A controller may be implemented with or without employing a processor, and also may be implemented as a combination of dedicated hardware to perform some functions and a processor (e.g., one or more programmed microprocessors and associated circuitry) to perform other functions. Examples of controller components that may be employed in various embodiments of the present disclosure include, but are not limited to, conventional microprocessors, application specific integrated circuits (ASICs), and field-programmable gate arrays (FPGAs).

The term “network” as used herein refers to any interconnection of two or more devices (including controllers or processors) that facilitates the transport of information (e.g. for device control, data storage, data exchange, etc.) between any two or more devices and/or among multiple devices coupled to the network. As should be readily appreciated, various implementations of networks suitable for interconnecting multiple devices may include any of a variety of network topologies and employ any of a variety of communication protocols. Additionally, in various networks according to the present disclosure, any one connection between two devices may represent a dedicated connection between the two systems, or alternatively a non-dedicated connection. In addition to carrying information intended for the two devices, such a non-dedicated connection may carry information not necessarily intended for either of the two devices (e.g., an open network connection). Furthermore, it should be readily appreciated that various networks of devices as discussed herein may employ one or more wireless, wire/cable, and/or fiber optic links to facilitate information transport throughout the network.

The term “user interface” as used herein refers to an interface between a human user or operator and one or more devices that enables communication between the user and the device(s). Examples of user interfaces that may be employed in various implementations of the present disclosure include, but are not limited to, switches, potentiometers, buttons, dials, sliders, a mouse, keyboard, keypad, various types of game controllers (e.g., joysticks), track balls, display screens, various types of graphical user interfaces (GUIs), touch screens, microphones and other types of sensors that may receive some form of human-generated stimulus and generate a signal in response thereto.

The term “lighting context” as used herein may refer to one or more identifiers associated with one or more light sources, as well as one or more lighting properties (e.g., hue, saturation, temperature, brightness, etc.) of each of the one or more light sources, as observed, detected or otherwise ascertained by a computing device. For example, if three different lights in a room, identified as “A,” “B” and “C,” are illuminated, a lighting context observed by a computing device in the room may include the three identifiers—A, B and C—as well as various lighting properties of those three light sources.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 schematically illustrates example components that may cooperate to facilitate selective advertisement of a user's availability to communicate, in accordance with various embodiments.

FIGS. 2-4 schematically illustrate example associations that may be created between one or more lighting contexts, one or more user activities, one or more potential availability statuses, and one or more other social network users/groups, in accordance with various embodiments.

FIG. 5 schematically depicts an example of a light source being commissioned, in accordance with various embodiments.

FIG. 6 schematically depicts an example user interface for associating one or more user activities, one or more potential availability statuses, and one or more other social network users/groups with a lighting context in accordance with various embodiments.

FIG. 7 schematically illustrates another example of components that may cooperate to facilitate selective advertisement of a user's availability to communicate, in accordance with various embodiments.

FIG. 8 schematically depicts an example method of facilitation of selective advertisement of a user's availability to communicate, in accordance with various embodiments.

### DETAILED DESCRIPTION

As mobile computing devices such as smart phones and computing tablets become more ubiquitous, it is possible to initiate communication with people at all times, which may increase stress to one who may not wish to be interrupted at particular times. Using context sensors such as a user's calendar to infer availability to communicate may require that the user manually maintain/update the calendar. Social networks are increasingly being used for communication as well, and may enable a social network user to advertise and/or update her “status.” While the user's status may be used by others to infer her availability to communicate, this still requires the user to manually update her status, or to have her status updated based on contextual sensors that require manual user maintenance.

Thus, Applicants have recognized and appreciated that it would be beneficial to make it more convenient for a user to notify others of her availability to communicate, without relying on data from contextual sensors that require manual maintenance by the user.

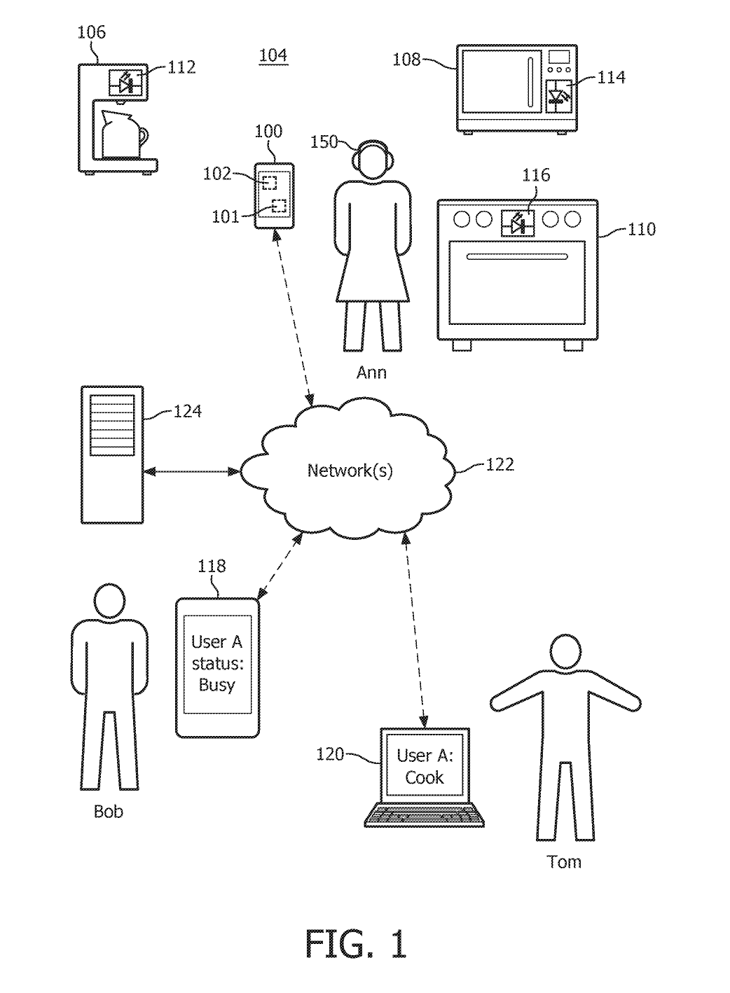

In view of the foregoing, various embodiments and implementations of the present invention are directed to facilitating selective advertisement of a user's availability to communicate based on an identifier associated with a light source and one or more lighting properties of the light source. Referring to FIG. 1, in one embodiment, a computing device takes the form of a smart phone 100 carried by a first user, Ann. In other embodiments, the computing device may be a computing tablet, a laptop, a stand-alone light-monitoring device, and so forth. Smart phone 100 may include a controller 101 and an optical sensor 102 coupled to controller 101. In various embodiments, optical sensor 102 may include a camera, a light measurement sensor, an infrared sensor, a coded light sensor, and so forth. Ann and her smart phone 100 are depicted in a kitchen 104 that contains a coffee maker 106, a microwave 108, and an oven 110.

In various embodiments, coffee maker 106, microwave 108 and/or oven 110 may include light sources in the form of LEDs 112, 114 and 116, respectively. In other embodiments, light sources associated with appliances or stand-alone light sources may be other types of light sources, such as incandescent, fluorescent, and so forth. In various embodiments, LEDs 112, 114 and 116 may emit light when the corresponding appliance is in use. In some cases, they may selectively emit light with various lighting properties (e.g., hue, saturation, temperature, brightness, etc.) depending on a mode of operation of the corresponding appliance. For instance, coffee maker 106 may cause its LED 112 to emit one hue when coffee is brewing, another hue after the coffee brewing has completed, and perhaps even a third hue some predetermined amount time after the coffee has brewed, e.g. to warn a user that the coffee may be stale and that a new pot should be brewed.

In various embodiments, controller 101 of smart phone 100 (hereinafter, smart phone 100 and/or “computing device” may be referred to interchangeably with controller 101) may be configured to obtain an identifier associated with a light source, such as one or more of LEDs 112, 114 and/or 116 associated with one or more of coffee maker 106, microwave 108 and/or oven 110. For example, in FIG. 1, smart phone 100 may receive one or more coded light signals, e.g., using optical sensor 102, from LEDs 112, 114 and/or 116. In various embodiments, these coded light signals may carry identifiers associated with LEDs 112, 114 and/or 116. In some cases, the identifiers associated with LEDs 112, 114 and/or 116 may correspond to identifiers associated with appliances 106, 108 and/or 110. However, this is not required, and in some cases, a light source may have its own identifier (which may or may not be unique), particularly where the light source is a stand-alone light source such as a lamp.

In addition to obtaining the one or more identifiers, in various embodiments, smart phone 100 may be configured to determine one or more lighting properties of each light source. For instance, smart phone 100 may be configured to determine, e.g., using optical sensor 102, whether one or more of LEDs 112, 114 and 116 are turned on, as well as lighting properties (e.g., hue, saturation, temperature, brightness, etc.) of light they emit. Contemporaneously-obtained/observed/ascertained light source identifiers and associated lighting properties may be referred to collectively as a “lighting context.” As will be described below, based on the obtained lighting context, smart phone 100 may facilitate selective advertisement of Ann's availability to communicate with one or more other users of a social network.

In FIG. 1, two other users—Bob and Tom—operate computing devices in the forms of another smart phone 118 and a laptop computer 120, respectively. These devices may enable Bob and Tom to communicate with Ann over one or more computing, cellular and/or other communication networks (hereinafter, “network 122”). In various embodiments, network 122 may include one or more local area networks (“LAN”), wide area networks (“LAN”), wireless wide area networks (“WWAN”), and so forth. In this example, smart phones 100 and 118, and laptop computer 120, connect wirelessly to networks 122, as indicated by the dashed lines. However, this is not meant to be limiting, and in various embodiments, similar communication computing devices may connect to network 122 using one or more wired connections.

Assume that Tom is Ann's husband, that Bob is Ann's boss, and that all three are members of a social network operated by one or more social network servers 124 (also connected to network 122). Bob and Tom may wish to contact Ann at various times, over the social network or using other means (e.g., phone call using cellular networks). However, before initiating communication with Ann, they may wish to determine Ann's availability to communicate at a particular moment beforehand, so that they can make an informed decision as to whether to disturb her.

Accordingly, in various embodiments, smart phone 100 may be configured to facilitate selective advertisement of the Ann's availability to communicate with other users, such as Bob and Tom, based on the one or more identifiers and lighting properties of light sources (e.g., LEDs 112-116) associated with Ann. For instance, smart phone 100 may detect that two or more of LEDs 112-116 are illuminated simultaneously, a lighting context that may suggest that Ann is cooking. When Ann is cooking, she may not wish to be interrupted except for emergencies. Accordingly, smart phone 100 may provide a command or other data to one or more social networking servers 124 that causes one or more social networking servers 124 to inform other social network users, e.g., using Ann's social network status update feature, of Ann's availability to communicate.

In some embodiments, smart phone 100 may select, from a plurality of potential availability statuses associated with a particular social network, an availability status that best suits Ann's current activity (cooking). That selected availability status may be included in the command smart phone 100 provides to one or more social network servers 124 that implement that particular social network. If Ann is a member of multiple social networks (e.g., social, business-related, etc.), smart phone 100 may select a suitable availability status from a plurality of potential availability statutes available at each social network. Thus, for instance, a personal social network may advertise Ann as “busy,” whereas a professional social network might advertise Ann's status as “do not disturb.”

In various embodiments, Ann's availability to communicate may be selectively advertised to users of the social network based on a relationship between Ann and a user to which the advertisement is directed. In this manner, people from which communications are likely to be more important to Ann at that particular moment may be provided with one availability status, and people from which communications are less likely to be important to Ann at that particular moment may be provided with another availability status. In various embodiments, Ann's relationships with other users such as Bob and Tom may be obtained from a social network to which Ann belongs, such as that operated by one or more social networking servers 124.

For instance, as Ann's husband, Tom may be a member of Ann's social networking group, “Close relatives.” By contrast, as Ann's boss, Bob may not be a member of Ann's “Close relatives” group, and may rather be a member of Ann's social networking group, “Office.” Smart phone 100 may be configured to cause one or more social network servers 124 to display a relatively specific availability status (e.g., “cooking”) to members of the “Close relatives” group, including Tom. Smart phone 100 may be configured to cause one or more social network servers 124 to provide a less specific availability status (e.g., “busy”) to members of the “Office” group, including Bob. In this manner, Tom is provided with more information than Bob, which enables Tom to make an informed decision about whether his purpose for contacting Ann at this particular moment is worth disturbing her. Bob only knows that Ann is “busy.” With so little information, Bob may be less likely to disturb Ann.

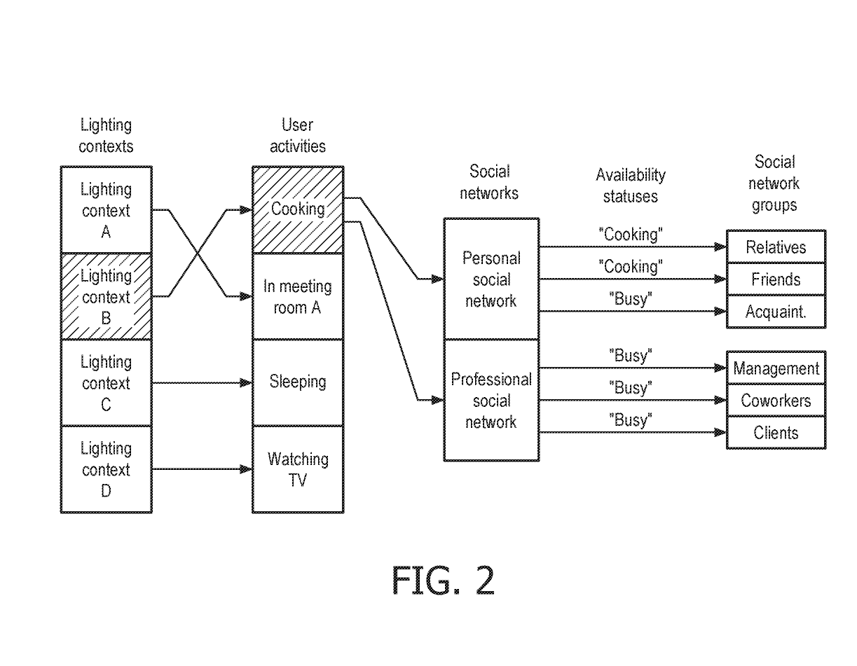

In various embodiments, users may create/generate/select activities in which they may participate. The users may then create associations between those activities, lighting contexts, and particular availability statuses on particular social networks. For instance, Ann may operate smart phone 100 or another computing device to generate a plurality of potential activities that she may participate in. Non-limiting examples of such activities are shown in FIG. 2, and include “cooking,” “in meeting room A,” “sleeping,” and “watching TV.” Based on lighting contexts of one or more light sources (e.g., LEDs 112-116), depicted in FIGS. 2-4 as LIGHTING CONTEXTs A-D, smart phone 100 may select an activity from Ann's plurality of potential activities in which she is participating. An availability status on one or more social networks may also be selected from a plurality of potential availability statuses, based on the selected user activity.

For instance, in FIG. 2, smart phone 100 has detected LIGHTING CONTEXT B (as indicated by the darkening of the box), which may include one or more of LEDs 112-116 in kitchen 104 being turned on and/or emitting light with various lighting properties. As shown by the arrows, this lighting context is associated with Ann's activity, “cooking.” Ann may have created this association herself, e.g., using smart phone 100 or another computing device, or it may have been created automatically, e.g., by virtue of LEDs 112-116 being associated with kitchen appliances.

Smart phone 100 may instruct a “PERSONAL SOCIAL NETWORK” to which Ann belongs to selectively provide availability statuses to three different groups. A first group, RELATIVES, and a second group, FRIENDS, may be notified that Ann is “COOKING.” A third group, ACQUAINT., may simply be notified that Ann is busy.

Smart phone 100 may also instruct a “PROFESSIONAL SOCIAL NETWORK” to which Ann belongs to selectively provide availability statuses to three different groups, MANAGEMENT, COWORKERS AND CLIENTS. However, because cooking may be the type of activity Ann participates when not at work, all three groups from the PROFESSIONAL SOCIAL NETWORK may receive the same availability status for Ann: “BUSY.”

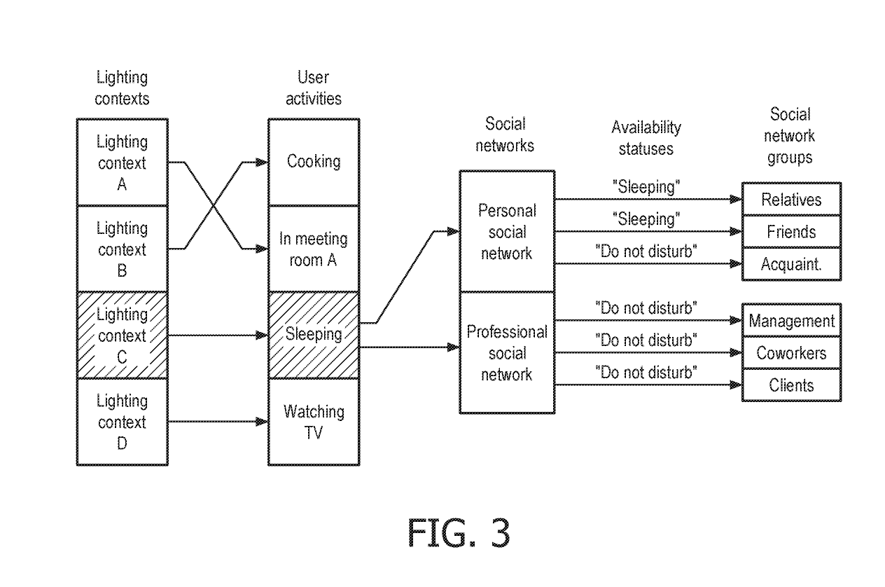

Different user activities may be associated with different availability statuses in different social networks. For instance, FIG. 3 depicts the same mapping of lighting contexts to Ann's potential activities as FIG. 2. In this instance, smart phone 100 has detected LIGHTING CONTEXT C. This lighting context may be associated with one or more light sources in Ann's bedroom (or another area in which she sleeps) emitting little or no light. In some instances, this lighting context may be further triggered by a time of day. For example, it may be active overnight and during any period of time during the day in which Ann typically naps.

In the example of FIG. 3, smart phone 100 may instruct the PERSONAL SOCIAL NETWORK to selectively provide availability statuses to three different groups. Members of RELATIVES and FRIENDS may be notified that Ann is “SLEEPING.” Members of ACQUAINT., in contrast, may be notified that Ann is not to be disturbed. Smart phone 100 may also instruct the PROFESSIONAL SOCIAL NETWORK to provide “DO NOT DISTURB” availability statuses to all three professional groups, MANAGEMENT, COWORKERS AND CLIENTS.

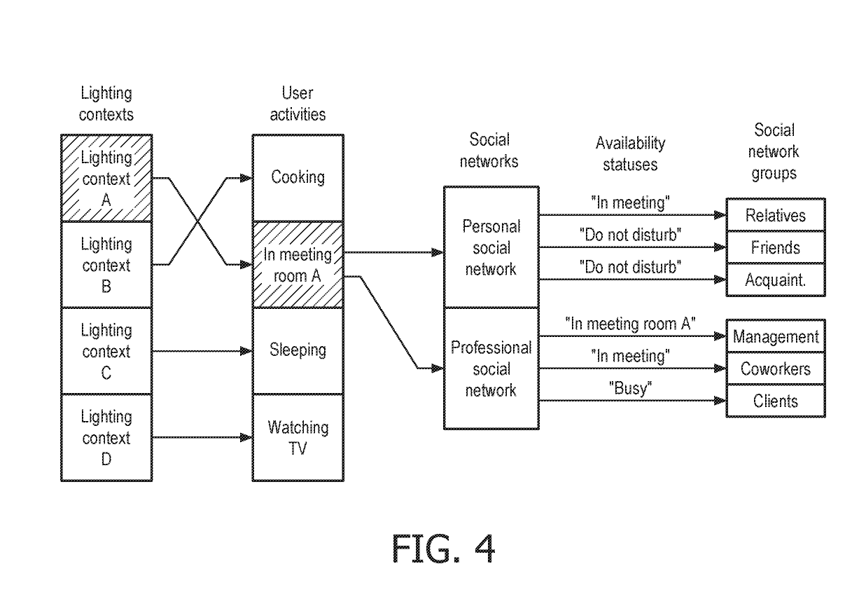

FIG. 4 depicts another example using the same mapping of lighting contexts to Ann's potential activities as in FIGS. 2 and 3. In this instance, smart phone 100 has detected LIGHTING CONTEXT A. This light context may be associated with one or more light sources in MEETING ROOM A (e.g., at Ann's office) emitting light with one or more lighting properties. In response to detect such a lighting context, smart phone 100 may instruct the PERSONAL SOCIAL NETWORK to selectively provide availability statuses to three different groups. Members of RELATIVES may be notified that Ann is “IN A MEETING.” This may suggest to close relatives that Ann may be contacted in case of an emergency, but not otherwise. Members of FRIENDS and ACQUAINT., in contrast, may be notified that Ann is not to be disturbed. Smart phone 100 may also instruct a PROFESSIONAL SOCIAL NETWORK to selectively provide availability statuses to three different professional groups. Members of MANAGEMENT may receive notification that Ann is “IN MEETING ROOM A,” because as her bosses, they may be entitled or expected to be able to interrupt Ann during such a meeting or even join her in the meeting. Members of COWORKERS are simply notified that Ann is “IN MEETING,” which may discourage them from attempting to communicate with her except in extenuating circumstances. Members of CLIENTS may simply be notified that Ann is “BUSY,” to discourage them from disturbing her without forbidding them to do so.

Associations between lighting contexts, user activities, social networks (e.g., availability statuses) and social network groups may be set by the user at various times, may be automatically created, and/or may have default settings. For instance, in some embodiments, Ann may manually configure, e.g., using smart phone 100 or another computing device, associations represented by the arrows in FIGS. 2-4.

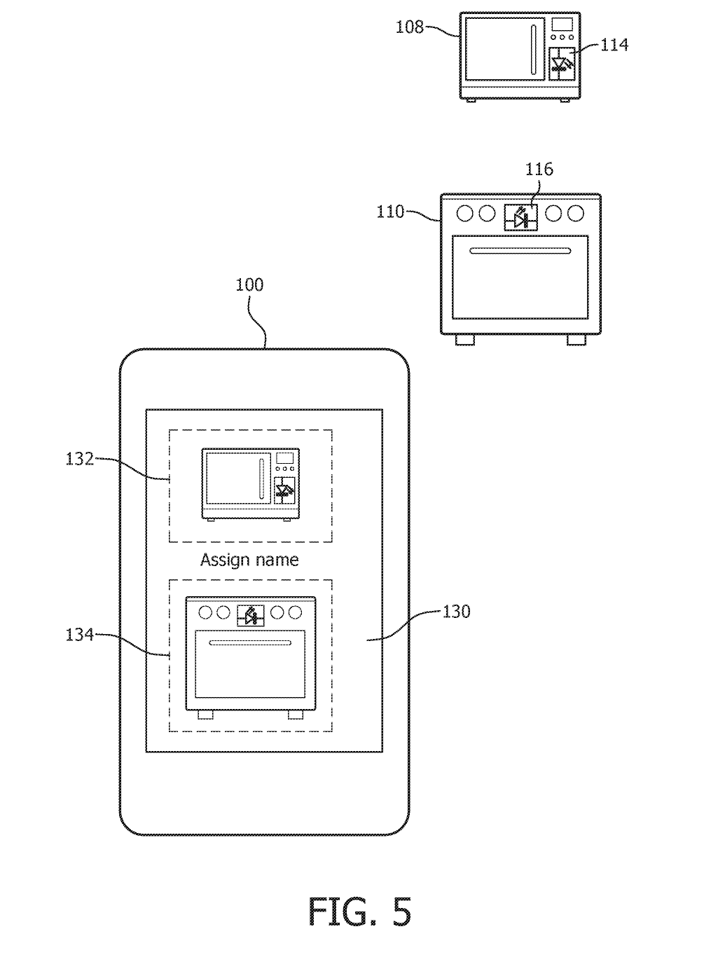

FIG. 5 depicts the initial step of a process, referred to herein as “commissioning,” in which a user may identify light sources and associate their lighting properties with various activities. Smart phone 100 is depicted in FIG. 5 with a display 130, which in some embodiments may be a touchscreen. To commission new light sources, smart phone 100 may be configured to capture a digital image of the surroundings that include the new light sources. For instance, smart phone 100 in FIG. 5 has captured an image of part of kitchen 104 that includes microwave 108 and oven 110 (see FIG. 1), e.g., using a camera (not shown). The digital image may be rendered on display 130. Light sources within the captured digital image may be automatically identified or selected by the user (e.g., Ann). Once identified, the light sources may be enclosed or otherwise indicated with a “tag box.” An active tag box 132 in FIG. 5 encompasses microwave 108, and requests that the user assign a name to LED 114 of microwave 108. An inactive tag box 134 encompasses oven 110, and may be selected by the user to assign a name to the light source it encompasses.

Once the user “tags” one or more light sources, the user may associate an activity with it/them. For example, Ann may assign the “COOKING” activity to one or more LEDs 112-116. When smart phone 100 detects one or more of these light sources emitting light, it may determine that Ann is cooking. Smart phone 100 may then cause one or more social networks to selectively advertise Ann's availability to communicate using one or more availability statuses to various groups of social network users, as demonstrated in FIGS. 2-4.

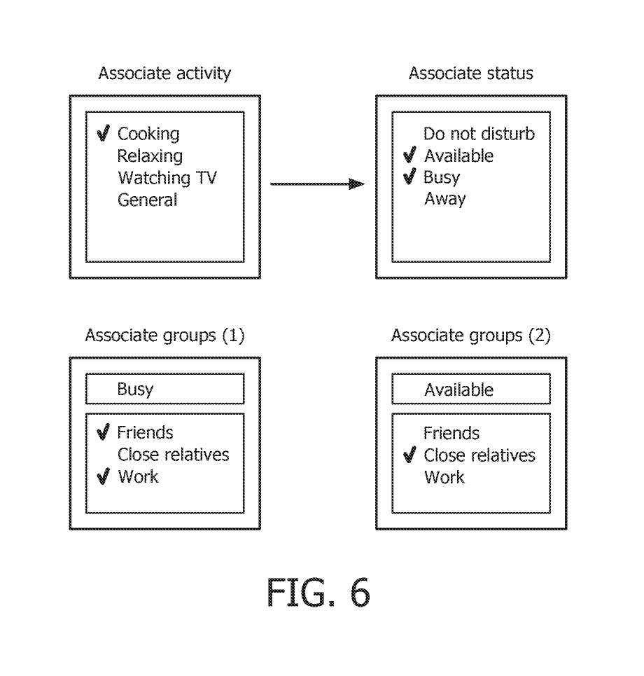

FIG. 6 depicts various states of an example user interface that a user such as Ann may operate to create associations between one or more of lighting contexts, user activities, social network availability statuses, and social network users/groups. This particular sequence may be presented to Ann in response to Ann “tagging” one or more kitchen light sources, as shown in FIG. 5. At the top left of FIG. 6, Ann has selected to associate the Activity “Cooking” with the tagged light sources. At the top right, one possible follow up menu enables Ann to select one or more potential availability statuses (e.g., which may be obtained from one or more social networks) for association with the activity, “Cooking.” Ann has selected both “Available” and “Busy.” The next menu, at bottom left, enables Ann to associate the selected availability status “Busy” with one or more groups of social network users. Ann has selected “Friends” and “Work,” which means members of those groups will be discouraged from contacting Ann. The next menu, at bottom right, enables Ann to associate the selected availability status “Available” with one or more groups of social network users. Ann has selected “Close relatives,” which means members of the “Close relatives” group will be informed that Ann is available for communication.

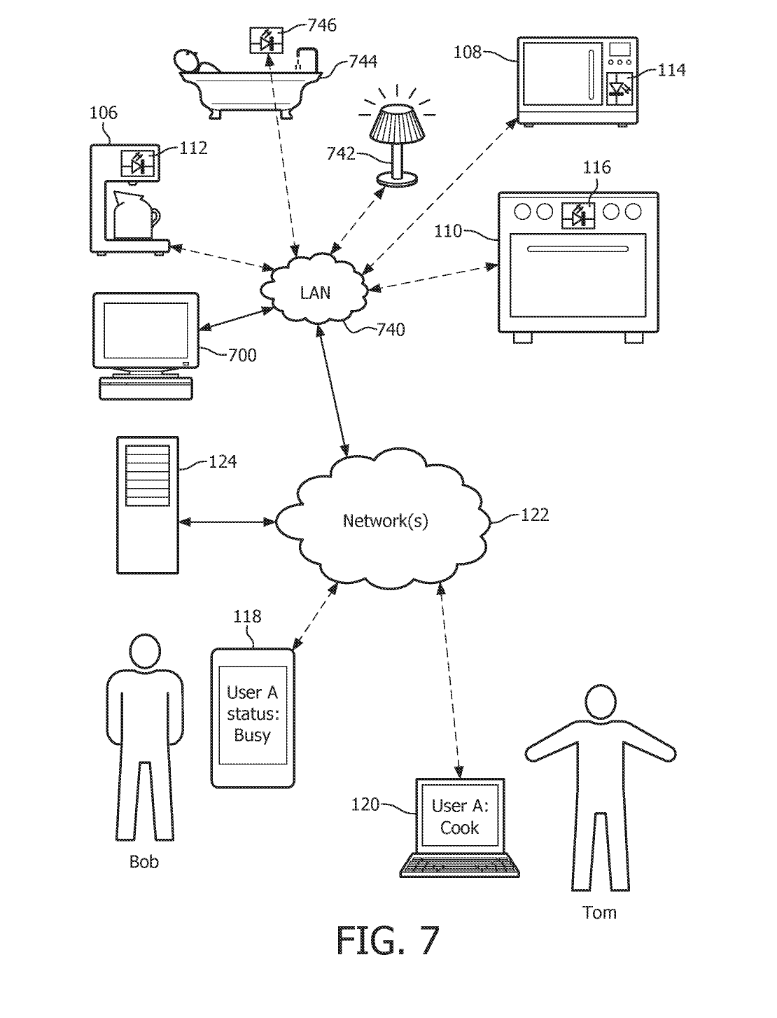

In various embodiments, computing devices other than a mobile computing device such as smart phone 100 or a tablet computer may be configured to determine lighting contexts and facilitate selective advertisement of availability statuses. FIG. 7 depicts an example scenario in which a computing device 700 performs functions similar to those performed by smart phone 100 in FIG. 1. Many other components in FIG. 7 are the same as those in FIG. 1, and are numbered the same.

Computing device 700 may be any sort of computing device, such as a desktop or laptop computer, a passive and monitor-less “box,” and so forth. In various embodiments, computing device 700 may be connected to a LAN 740, which may be wireless and/or wired. LAN 740 may in turn be connected to network 122, e.g., using a wired connection as shown in FIG. 7, or a wireless connection.

In various embodiments, rather than observing lighting contexts, as smart phone 100 did using optical sensor 102 in FIG. 1, computing device 700 may receive lighting contexts from one or more the light sources over LAN 740. For example, in FIG. 7, in addition to LEDs 112-116 associated with kitchen appliances 106-110, a standalone lamp 742 and an overhead LED 746 above a bathtub 744 are also depicted. One or more of light sources 112-116, 742 and 746 may be in network communication with computing device 700 over LAN 740, and may communicate local lighting settings to computing device 700. Computing device 700 in turn may facilitate selective advertisement of Ann's availability to communicate based on this information.

In addition to or instead of enabling user creation of associations between lighting contexts, potential availability statuses and social network users/groups, in some embodiments, these associations may be generated automatically, e.g., based on one or more characteristics of a light source. For instance, in FIG. 7, LED 746 above bathtub 744 may have a characteristic of a “bathroom light fixture.” LED 746 may provide this characteristic to computing device 700. Computing device 700 in turn may automatically associate one or more lighting properties of LED 746 with a user activity of “In the bathroom.” Most users would presumably prefer not to be disturbed in the bathroom, and so in various embodiments, computing device 700 may automatically associate the activity “In the bathroom” with potential availability statuses that are likely to discourage contact, such as “busy” or “do not disturb.”

Referring back to FIG. 1, a mobile computing device such as smart phone 100 may not always be the ideal means for determining which lights a user such as Ann is currently using. Ann may keep smart phone 100 in her pocket, in which case optical sensor 102 may be unable to obtain light source identifiers or detect lighting properties of light sources. In such case, a computing device may be provided that is more likely to be within line of sight of light sources.

For example, in some embodiments, instead of or in addition to smart phone 100, a wearable computing device 150 may be provided. Wearable device 150 may come in various forms. In FIG. 1, it is a headset, but in other embodiments, it could be another type of wearable computer, such as an arm band, a wrist watch, a device secured to clothing such as a hat, an optical head-mounted display, and so forth. In some cases, wearable computing device 150 may be in wireless or wired communication with smart phone 100, e.g., using Bluetooth or other similar technologies, and may cause smart phone 100 to implement the selective advertisement described above. In other embodiments, wearable computing device 150 may act alone to perform the functions attributed to smart phone 100 above, including obtaining light source identifiers and lighting properties, and facilitating selective advertisement of a user's availability to communicate.

In another aspect, smart phone 100 or computing device 700 may be configured to monitor lighting properties of one or more light sources. Smart phone 100 or computing device 700 may be further configured to selectively raise an alarm to one or more users (e.g., family members, medical personnel, police, etc.) in response to an observed deviation from an established routine of lighting properties of the monitored light source(s) over time.

Assume Ann is in failing health. Smart phone 100, wearable computing device 150 or computing device 700 may be configured, e.g., by Ann or by Ann's family or doctors, to monitor a particular light source, e.g., standalone lamp 742. If standalone lamp 742 is not illuminated for a predetermined time, smart phone 100 or computing device 700 may be configured to raise an alarm, e.g., to Ann's family members or doctor. Those persons may then take appropriate action, such as attempting to contact Ann and/or visiting Ann's home to make sure Ann is OK. In various embodiments, the predetermined amount of time may be set by appropriate persons, such as Ann's family or doctors. Additionally, smart phone 100 or computing device 700 may be configured to take into account other data associated with Ann, such as data from Ann's online calendar, to determine whether raising an alarm is really necessary. For instance, if Ann's calendar says she is travelling, then it may not be appropriate to raise an alarm even if the predetermined amount of time passes without standalone lamp 742 being illuminated.

In addition to or instead of facilitating selective advertisement of a user's availability to communicate, in some embodiments, smart phone 100 and/or computing device 100 may take other actions based on lighting properties of one or more light sources. For instance, in some embodiments, smart phone 100 may alter an incoming message notification setting of smart phone 100 based on the determined one or more lighting properties and the obtained identifier. If smart phone 100 detects light emitted from a commissioned light source in a particular meeting room, smart phone 100 may deduce that the user is in a meeting. In such case, in addition to or instead of facilitating selective advertisement of the user as being busy, smart phone 100 may also switch to a less intrusive mode, such as silent or vibrate, or may even block incoming calls altogether.

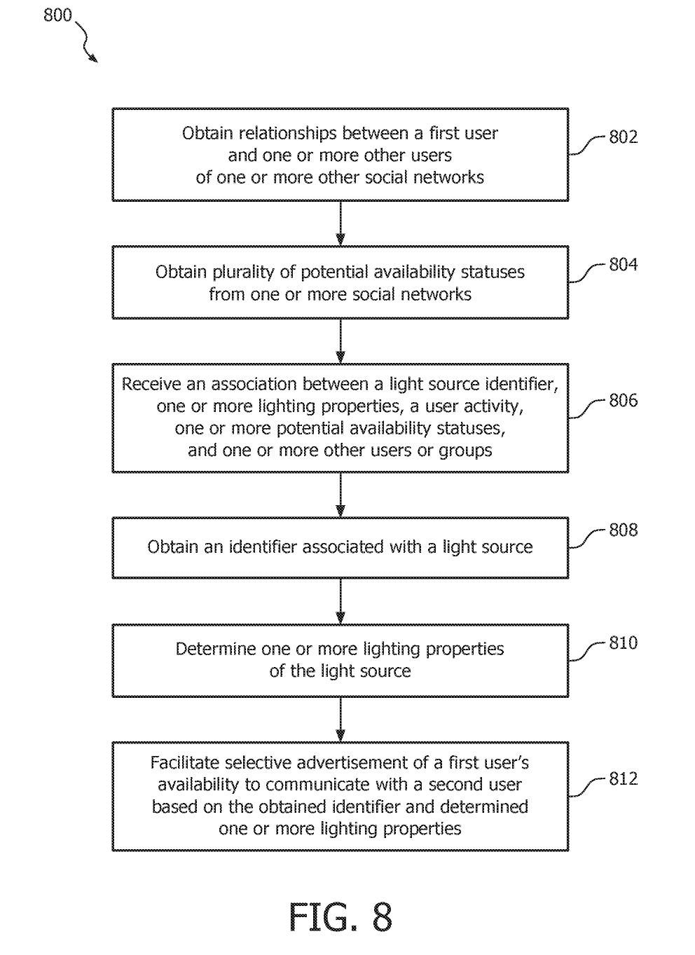

FIG. 8 depicts an example method 800 that may be implemented by a computing device such as smart phone 100, wearable computing device 150 and/or computing device 700, in accordance with various embodiments. At block 802, one or more relationships between a first user, who may be an operator of or otherwise associated with the computing device, and one or more other users of one or more social networks may be obtained or otherwise ascertained. In some embodiments, smart phone 100 may store the first user's social network “friends” in memory of smart phone 100, e.g., in association with a locally-installed social networking application. In some embodiments, smart phone 100 may additionally or alternatively obtain the relationships from the social network(s) over one or more computer networks (e.g., 122). Obtaining or otherwise ascertaining relationships may also include obtaining or otherwise ascertaining one or more groups of social network users associated with the first user, such as “Close relatives,” “coworkers,” etc.

At block 804, a plurality of potential availability statuses may be obtained from a social network or otherwise ascertained. In some embodiments, smart phone 100 may store these potential availability statuses in memory, e.g., in association with a locally-installed social networking application. In some embodiments, smart phone 100 may obtain these potential availability statuses from a social network over one or more networks (e.g., 122).

At block 806, one or more associations may be received, e.g., by smart phone 100 from the first user operating an interface such as the one depicted in FIG. 6. As depicted in FIGS. 2-4, these associations may be between one or more lighting contexts (e.g., lighting identifiers associated with light sources and potential lighting properties of those light sources), one or more user activities, one or more of the potential availability statuses obtained/ascertained at block 804, and one or more other users or groups (e.g., obtained at block 802). In some embodiments, the operations at block 806 may be commenced by a user commissioning a particular light source, e.g., by “tagging” that light source in a rendered digital image of the light source in its surroundings.

At block 808, an identifier associated with a light source may be obtained. For instance, in some embodiments, such as that depicted in FIG. 1, a computing device such as smart phone 100 or wearable computing device 150 may receive, e.g., via optical sensor 102 from the light source, a coded light signal carrying an identifier associated with the light source. In other embodiments, such as that depicted in FIG. 7, a computing device such as computing device 700 may receive an identifier associated with a light source through one or more computer networks (e.g., 122), e.g., from the light source itself.

At block 810, one or more lighting properties (e.g., hue, brightness, spatial or temporal patterns, temperature, saturation, etc.) may be determined. For instance, in some embodiments, such as that depicted in FIG. 1, a computing device such as smart phone 100 or wearable computing device 150 may detect, e.g., via optical sensor 102 from the light source, one or more lighting properties of light emitted by the light source. In other embodiments, such as that depicted in FIG. 7, a computing device such as computing device 700 may receive an indication of one or more lighting properties of a light source through one or more computer networks (e.g., 122), e.g., from the light source itself.

At block 812, the computing device may facilitate selective advertisement of the first user's availability to communicate with one or more other users or groups of users. For instance, smart phone 100, wearable computing device 150 and/or computing device 700 may determine a current activity of the first user based on identifier obtained at block 808 and the lighting properties obtained at block 810. Based on the determined user activity, the computing device may select, e.g., from the plurality of potential availability statuses obtained/ascertained at block 804, one or more availability statuses associated with the determined activity. Smart phone 100, wearable computing device 150 and/or computing device 700 may then cause one or more social networks to selectively advertise one of the selected availability statuses to other users/groups of the social network, based on who is viewing the advertisement.

In some embodiments, blocks 802-806 may be performed prior to blocks 808-812. For example, smart phone 100 may periodically obtain social network data, and may receive user associations at the convenience of the user. Blocks 808-812 may then be performed at various times, such as on detection of a change in lighting by smart phone (e.g., when the user enters a different room, or alters the lighting in a room). In other embodiments, at least some of blocks 802-806 may be performed contemporaneously with blocks 808-812. For instance, upon detecting a change in lighting, smart phone 100 may perform the operations of blocks 802 and/or 804, and then perform the operations at blocks 808-812.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. It should also be understood that, unless clearly indicated to the contrary, in any methods claimed herein that include more than one step or act, the order of the steps or acts of the method is not necessarily limited to the order in which the steps or acts of the method are recited.

Reference numerals appearing in the claims between parentheses, if any, are provided merely for convenience, and should not be construed to limit the claims in any way.

1. A computing system, comprising a controller configured to:
obtain, from a light source, an identifier associated with the light source,
provide a user interface that includes a representation of the light source;
receive, from a first user via the user interface, an association between the identifier of the light source, one or more potential lighting properties of the light source, and one or more potential availability statuses of the first user;
determine one or more lighting properties of the light source; and
facilitate selective advertisement of a first user's availability to communicate with a second user based on the association and the determined one or more lighting properties.

2. The computing system of claim 1, wherein the selective advertisement of the first user's availability to communicate is further based on a relationship between the first user and the second user.

3. The computing system of claim 2, wherein the relationship is obtained from a social network to which the first and second users belong.

4. The computing system of claim 2, wherein the selective advertisement further comprises selection, for provision to the second user, of an availability status from a plurality of potential availability statuses based on the relationship between the first and second users.

5. (canceled)

6. The computing system of claim 4, wherein the controller is further configured to select an activity of the first user from a plurality of potential activities of the first user based on the determined one or more lighting properties of the light source and the obtained identifier, and wherein the availability status is selected from the plurality of potential availability statuses based on the selected activity.

7. (canceled)

8. The computing system of claim 2, wherein the first user's availability to communicate is selectively advertised on a social network to which the first and second users belong.

9. The computing system of claim 1, wherein the computing system comprises a mobile computing device equipped with an optical sensor, and wherein the determination of the one or more lighting properties comprises detection of the one or more lighting properties using the optical sensor.

10. The computing system of claim 1, wherein the identifier associated with the light source is obtained from a coded light signal received by the computing system from the light source.

11. (canceled)

12. (canceled)

13. The computing system of claim 1, wherein the controller is further configured to enable the first user to tag the light source within a rendered digital image of the light source and its surroundings.

14. The computing system of claim 1, wherein the controller is further configured to automatically generate, based on a characteristic of the light source, an association between the identifier of the light source, one or more potential lighting properties of the light source, and one or more potential availability statuses of the first user.

15. (canceled)

16. The computing system of claim 1, wherein the computing system comprises a wearable computing device, the facilitation comprises provision of an instruction by the wearable computing device to a mobile computing device, and the instruction is configured to cause the mobile computing device to implement the selective advertisement.

17. (canceled)

18. The computing system of claim 1, wherein the computing system is a smart phone, and the controller is further configured to alter an incoming message notification setting of the smart phone based on the determined one or more lighting properties and the obtained identifier.

19. A computer-implemented method, comprising:
obtaining, by a computing device, an identifier associated with a light source;
receiving, by the computing device from a first user via a user interface that includes a graphical representation of the light source, an association between the identifier of the light source, one ore more potential lighting properties of the light source, and one or more potential availability statuses of the first user;
determining, by the computing device, one or more lighting properties of the light source; and
facilitating, by the computing device, selective advertisement of a first user's availability to communicate with a second user based on the obtained identifier and the determined one or more lighting properties.

20. The computer-implemented method of claim 19, wherein the selective advertisement of the first user's availability to communicate is further based on a relationship between the first user and the second user.

21. The computer-implemented method of claim 20, further comprising obtaining the relationship from a social network to which the first and second users belong.

22. (canceled)

23. (canceled)

24. (canceled)

25. The computer-implemented method of claim 19, further comprising:
rendering, by the computing device on a display, a rendered digital image of the light source and its surroundings, wherein the rendered digital images includes a tag box to represent that a portion containing the light source is selectable; and
receiving, by the computing device from the first user, an indication that the user has tagged the light source in the rendered digital image by selecting the tag box.

26. The computer-implemented method of claim 20, wherein the user's availability to communicate is selectively advertised on a social network to which the first and second users belong.

27. The computer-implemented method of claim 19, wherein the computing device comprises a mobile computing device equipped with an optical sensor, and wherein determining the one or more lighting properties comprises detecting the one or more lighting properties using the optical sensor.

28. The computer-implemented method of claim 19, wherein obtaining the identifier associated with the light source comprises obtaining the identifier from a coded light signal received by the computing device from the light source.

29. At least one non-transitory computer-readable medium comprising instructions that, in response to execution of the instructions by a computing device, cause the computing device to perform the method of claim 19.
